(19) United States
(12) Patent Application Publication
(10) Pub. No.: US 2023/0150331 A1
(43) Pub. Date: May 18, 2023

(54) VEHICLE WITH SUSPENSION-CONTROLLED MOTION RESISTANCE MEMBERS

(71) Applicant: SONY GROUP CORPORATION, Tokyo (JP)

(72) Inventors: Ted Yamazaki, San Diego, CA (US); Tonni Larsen, San Diego, CA (US)

(21) Appl. No.: 17/526,892

(22) Filed: Nov. 15, 2021

(51) Int. Cl. B60G 17/0165; B60K 7/00; B60G 17/016; B60G 17/019; B60G 21/00

(52) U.S. Cl. CPC B60G 17/0165; B60K 7/0007; B60G 17/0164; B60G 17/019; B60G 21/002; B60G 2400/106; B60G 2400/821; B60G 2500/30

(57) ABSTRACT

A vehicle with suspension-controlled motion resistance members is provided. The vehicle includes a body and a chassis coupled to a base of the body. The vehicle further includes a motion resistance member that is coupled to a base surface of the chassis, a wheel assembly coupled to the chassis, and a suspension unit coupled to the wheel assembly and the chassis. In an actuated state, the suspension unit is configured to move the chassis in a first direction until at least a portion of the motion resistance member contacts a ground below the base surface of the chassis.

### CROSS-REFERENCE TO RELATED APPLICATIONS/INCORPORATION BY REFERENCE

None.

### FIELD

Various embodiments of the disclosure relate to vehicle technology and advanced suspension and braking systems. More specifically, various embodiments of the disclosure may relate to a vehicle with suspension-controlled motion resistance members.

### BACKGROUND

Advancements in vehicle technology have led to development of various types of braking mechanisms that improve a braking performance of a vehicle for different terrains, weather conditions, and/or speed requirements. For a vehicle to increase its speed, a force resulting in a forward motion may be required. Similarly, to stop or slow down, a force resulting in a motion in an opposite direction (rearward) may be required. These forces may be transferred between the tires of the vehicle and the surface of the road, through a portion of the tires that may be in contact with the surface of the road. The portion of the tire in contact with the surface is typically referred to as a contact patch. The contact patch may affect the braking performance as well as parameters related to a driving performance or a riding comfort of the vehicle. Many drivers and vehicle manufacturers factor in the size and shape of the contact patch, as well as a pressure distribution within the contact patch to optimize a ride quality and handling performance of a vehicle. Vehicles which use pneumatic tires can have a different contact patch size depending on whether the vehicle is in motion or is at rest. In addition, the size and shape of the contact patch can vary from one vehicle to another because of various factors, such as a tire size, a load on the tire, an inflation pressure of tires. Many vehicles, especially modern electric vehicles have a lower weight than most known combustion-based vehicles. The contact patch for such vehicles can be lower than normal, which can result in a poorer braking and handling performance of the vehicle.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A vehicle with suspension-controlled motion resistance members is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a diagram of an exemplary vehicle with suspension-controlled motion resistance members, in accordance with an embodiment of the disclosure.

FIG. 2 is a diagram of an exemplary vehicle that includes an electronic controller coupled with a chassis, to inhibit a movement of the vehicle, in accordance with an embodiment of the disclosure.

FIG. 3 is a diagram that illustrates a first exemplary scenario to inhibit a movement of the vehicle of FIG. 1, in accordance with an embodiment of the disclosure.

FIGS. 4A, 4B, 4C, 4D, and 4E are diagrams that collectively illustrate a plurality of scenarios related to a movement of a chassis of the vehicle of FIG. 1, in accordance with an embodiment of the disclosure.

FIGS. 5A and 5B are diagrams that collectively illustrate an exemplary scenario to park the vehicle of FIG. 1, in accordance with an embodiment of the disclosure.

FIGS. 6A, 6B, and 6C are diagrams that collectively illustrate an exemplary scenario for emergency braking of the vehicle of FIG. 1, in accordance with an embodiment of the disclosure.

FIG. 7 is a diagram that illustrates an exemplary scenario to detach a wheel of the vehicle of FIG. 1, in accordance with an embodiment of the disclosure.

FIG. 8 is a diagram that illustrates a second exemplary scenario to inhibit a movement of the vehicle of FIG. 1, in accordance with an embodiment of the disclosure.

FIG. 9 is a diagram of an exemplary vehicle that includes a chassis and an axle coupled to the chassis, in accordance with an embodiment of the disclosure.

FIG. 10 is a flowchart that illustrates an exemplary method to inhibit a movement of the vehicle via the chassis of the vehicle of FIG. 1, in accordance with an embodiment of the disclosure.

### DETAILED DESCRIPTION

The following described implementations may be found in a vehicle such as a car. The vehicle may include a body and a chassis coupled to a base of the body of the vehicle. The vehicle may further include a motion resistance member (such as one or more grip pads or wheels) that may be coupled to a base surface of the chassis. At any time, if the vehicle attempts to slow down, apply emergency brakes, or park itself on a road or other surface, the base surface of the chassis may move in a direction (such as downwards) such that the motion resistance member or a portion thereof contacts the ground below the base surface. The contact with the ground may generate an additional friction on the road surface in addition to a friction generated by wheels of the vehicle. Based on a total produced friction, the vehicle may be able to reduce its braking distance in case of emergency braking and may gain additional force needed to safely park or slow down the vehicle. The motion resistance member may provide an additional contact area with a surface of the road in comparison to a contact patch offered by typical wheels of the vehicle.

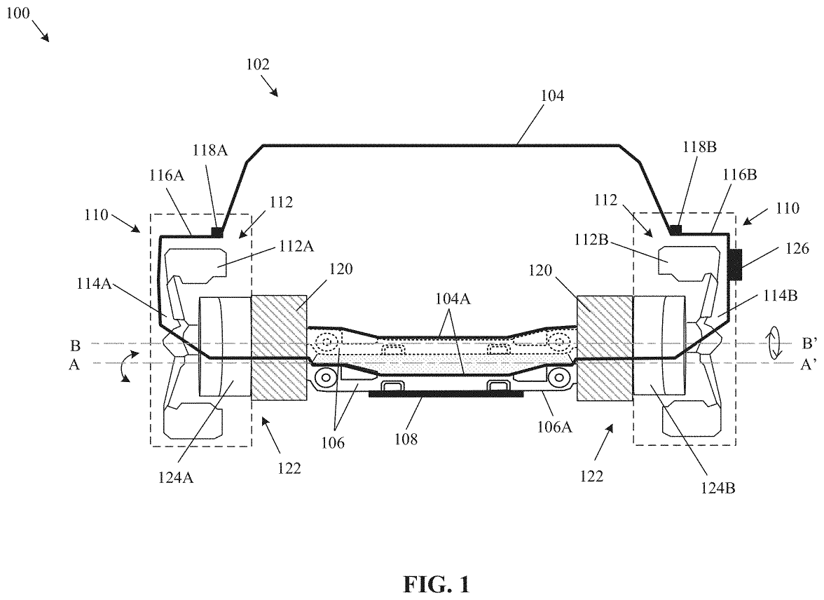

FIG. 1 is a diagram of an exemplary vehicle with suspension-controlled motion resistance members, in accordance with an embodiment of the disclosure. With reference to FIG. 1, there is shown a vehicle 102. The vehicle 102 may have provisions to be a non-autonomous vehicle, a semi-autonomous vehicle, or a fully autonomous vehicle, for example, as defined by Society of Automotive Engineers (SAE) automation levels. Based on a type of propulsion, the vehicle 102 may be classified as one of a fossil fuel-based vehicle, an electric propulsion-based vehicle, a hydrogen fuel-based vehicle, a solar-powered vehicle, or a hybrid vehicle (such as a vehicle that uses one or more distinct renewable or non-renewable power sources). Examples of the vehicle 102 may include, but are not limited to, a two-wheeler vehicle, a three-wheeler vehicle, a four-wheeler vehicle, or a ground-transport vehicle with a propulsion mechanism that uses any number of wheels or any other alternative to wheels.

The vehicle 102 may include a body 104. The body 104 may be a frame having at least one pillar, which may enclose a first part (such as a top portion) of the vehicle 102. In an embodiment, the at least one pillar (such as A-pillar, B-pillar, C-pillar or D-pillar) may extend in a direction that is substantially perpendicular from a vehicle-length direction associated with the vehicle 102. In accordance with an embodiment, the body 104 may include a plurality of mount locations to accommodate several components of the vehicle 102. For example, the body 104 may include at least one wheel-mount location to mount at least one wheel of the vehicle 102. As another example, the body 104 may include a cover over a section of the at least one wheel-mount location to partially enclose the at least one wheel-mount location. As another example, the body 104 may include a base 104A (i.e., a chassis-mount location) that may be disposed over a chassis 106 of the vehicle 102. In an embodiment, the base 104A may be located adjacent to the at least one wheel, which may be configured to be mounted on the chassis 106 of the vehicle 102.

The chassis 106 may be a frame having at least one cross-member between a pair of side members, which may be configured to support a load of the vehicle 102. In an embodiment, the at least one cross-member may extend in a direction that may be substantially parallel to the direction of the length of the vehicle 102. In an embodiment, the chassis 106 may be coupled to the base 104A of the body 104. For example, the chassis 106 may be integrally welded to the base 104A of the body 104 or may be removably fastened to the base 104A of the body 104. In an embodiment, the chassis 106 may include a base surface 106A, which may be configured to be coupled with a motion resistance member 108 of the vehicle 102.

The motion resistance member 108 may be coupled to the base surface 106A of the chassis 106, via an attachment implement. Examples of the attachment implement may include, but are not limited to, a mechanical fastener, a chemical adhesive, a magnetic latch, a weld joint, or an electromagnetic latch. In an embodiment, the motion resistance member 108 may be disposed along the length of the chassis 106. For example, the motion resistance member 108 may be disposed in a direction that may be substantially parallel to the length of the chassis 106.

The motion resistance member 108 may be configured to contact a ground below the base surface 106A of the chassis 106. The contact with the ground may be controlled based on a requirement to stop, slow down, or park the vehicle 102. In accordance with an embodiment, the motion resistance member 108 may be made of a rubber material. The rubber material (for example, a synthetic rubber) may be configured to resiliently-cushion an impact that may be generated when the motion resistance member 108 contacts the ground surface. The impact may be generated, for example, when the vehicle 102 decelerates to stop or slow down. In another embodiment, the motion resistance member 108 may be made of a metallic material. The metallic material (for example, a hot-rolled steel) may be configured to improve a wear resistance against the impact that may be generated when the motion resistance member 108 contacts the ground surface. In another embodiment, the motion resistance member 108 may be made of a composite material (for example, carbon fibers) and/or reinforced material (for example, carbon fiber reinforced polymers). The composite material and/or the reinforced material may be configured to improve a load transfer path of the impact that may be generated when the motion resistance member 108 contacts the ground surface. Other examples of materials that can be used to make the motion resistance member 108 or at least a portion of the motion resistance member 108 (that may contact the ground below the base surface 106A) may include, but are not limited to, asbestos organic, non-asbestos organic, semi-metallic, sintered metallic, and carbon composite. Details of the motion resistance member 108 are further provided, for example, in FIG. 3.

The vehicle 102 may further include a wheel assembly 110. The wheel assembly 110 may be coupled to the chassis 106. In accordance with an embodiment, the wheel assembly 110 may include a set of wheels 112 disposed in a set of wheel-mount locations on the body of the vehicle 102 and coupled to corresponding part of the chassis 106. As an example, a first wheel 112A may be disposed in a first wheel-mount location 114A and may be detachably coupled to a first part of the chassis 106. A second wheel 1128 may be disposed in a second wheel-mount location 1148 and may be detachably coupled to a second part of the chassis 106. It should be noted that the vehicle 102 may include any number of wheels (for example, three wheels, four wheels, and the like) that may be located in respective wheel-mount locations on the body of the vehicle 102 and may be detachably coupled to respective parts of the chassis 106.

In an embodiment, the body 104 may include a first cover 116A and a second cover 1168. The first cover 116A may be detachably disposed over a section of the first wheel-mount location 114A. For example, the first cover 116A and the body 104 may be coupled via a first releasing member 118A, which may be configured to detach the first cover 116A from the body 104. The second cover 1168 may be detachably disposed over the section of the second wheel-mount location 1148. For example, the second cover 1168 and the body 104 may be coupled via a second releasing member 1188, which may be configured to detach the second cover 116B from the body 104.

The first cover 116A and the second cover 1168 can be detached via the first releasing member 118A and the second releasing member 1188, respectively, based on user requirements. In an embodiment, the first releasing member 118A and the second releasing member 1188 may be mechanically fastened members (such as a slidable latch) that may be configured to detach a corresponding cover from the body 104. In another embodiment, the first releasing member 118A and the second releasing member 118B may be electromagnetic release members (such as electromagnetic latches) that may be configured to detach a corresponding cover from the body 104 of the vehicle 102.

The vehicle 102 may further include a suspension unit 120 that may be coupled to the wheel assembly 110 and the chassis 106. For instance, the suspension unit 120 may be disposed between the wheel assembly 110 and the chassis 106. In accordance with an embodiment, the suspension unit 120 may correspond to an active suspension mechanism that may be disposed between the wheel assembly 110 and the chassis 106. In an active state, the suspension unit 120 may include an onboard control system to control a vertical movement of the set of wheels 112 of the vehicle 102 relative to the chassis 106 or the body 104 of the vehicle 102. Example implementation of the active suspension mechanism may include, but are not limited to, hydraulic actuation, electronic actuation of hydraulic suspension, active anti-roll bar, electromagnetic recuperative, active wheel, solenoid/valve actuated, and magnetorheological damper. In accordance with another embodiment, the suspension unit 120 may correspond to a semi-active suspension mechanism or a passive suspension mechanism.

In an actuated state, the suspension unit 120 may be configured to move the chassis 106 in a first direction until at least a portion of the motion resistance member 108 contacts a ground below the base surface 106A of the chassis 106. For example, the first direction may correspond to a downward direction from the base surface 106A of the chassis 106 that may be directed towards the ground below the base surface 106A of the chassis 106.

In accordance with an embodiment, the movement of the chassis 106 in the first direction may correspond to adjustment of at least one of a height of the chassis 106 or an inclination of the chassis 106 with respect to the ground below the base surface 106A of the chassis 106. For example, the chassis 106 may be moved linearly with respect to the ground to adjust the height of the chassis 106 with respect to the ground. In such a case, the entire surface portion of the motion resistance member 108 that is parallel to the chassis 106 may contact the ground. In some embodiments, the chassis 106 may be moved non-linearly with respect to the ground to adjust the inclination of the chassis 106 with respect to the ground. In some other embodiments, the movement of the chassis 106 may be around a pivot axis AA′ that may be substantially parallel to a rotational axis BB′ of wheels (such as the set of wheels 112) of the wheel assembly 110. The portion such as a first end (for example, a front end) of the motion resistance member 108 or a second end (for example, a rear end) of the motion resistance member 108 may contact the ground. In some embodiments, the body 104 of the vehicle 102 may move down along with the movement of the chassis 106. Details of the movement of the motion resistance member 108 are further provided, for example, in FIG. 3.

In accordance with an embodiment, the vehicle 102 may further include a drive system 122 that may include an in-wheel motor around each wheel of the set of wheels 112. The drive system 122 may include suitable logic, circuitry, and interfaces that may be configured to control transfer of electric power to various electrical or electromechanical components of the vehicle 102.

The in-wheel motor such as a first in-wheel motor 124A may be coupled to the first wheel 112A of the wheel assembly 110. A second in-wheel motor 1248 may be coupled to the second in-wheel motor 1248 of the wheel assembly 110. Similarly, respective in-wheel motors may be coupled to a third wheel and a fourth wheel (not shown) of the set of wheels 112. Further, the in-wheel motors such as the first in-wheel motor 124A and the second in-wheel motor 124B may be configured to power the respective wheels of the vehicle 102. For example, the first in-wheel motor 124A may be configured to power the first wheel 112A and the second in-wheel motor 1248 may be configured to power the second wheel 1128.

The drive system 122 may provide the electric power for functioning of different components (not shown in FIG. 1), such as an electronic controller, electric motor(s), infotainment system, display device(s), onboard computer(s), a communication system, a memory, and a set of sensors of the vehicle 102. The drive system 122 may be configured to receive control signals from the electronic controller to control various electronic components of the vehicle 102. The drive system 122 may be also be configured to control a charging and a discharging of a battery of the vehicle 102 based on the received control signals.

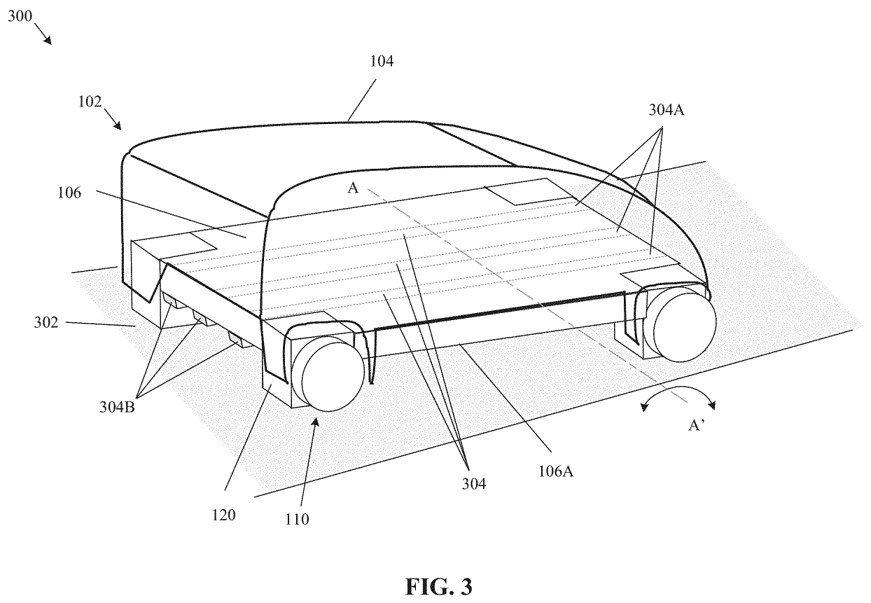

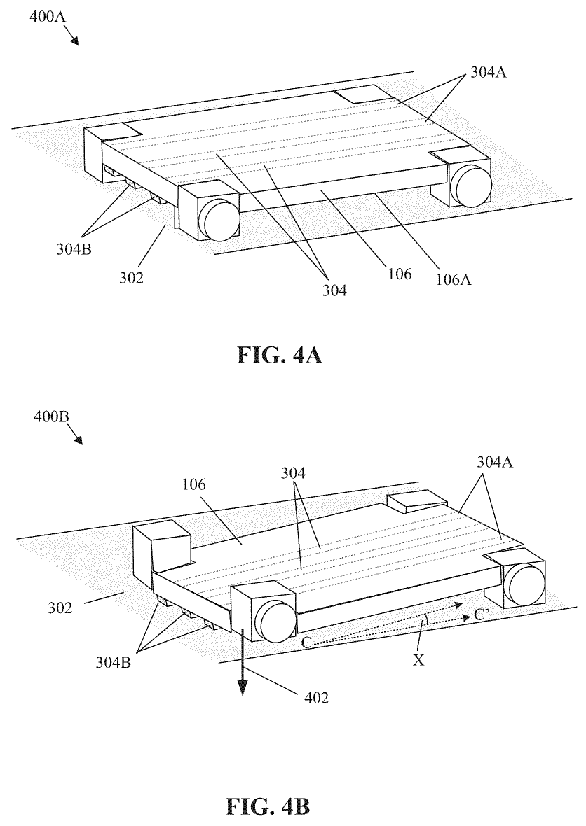

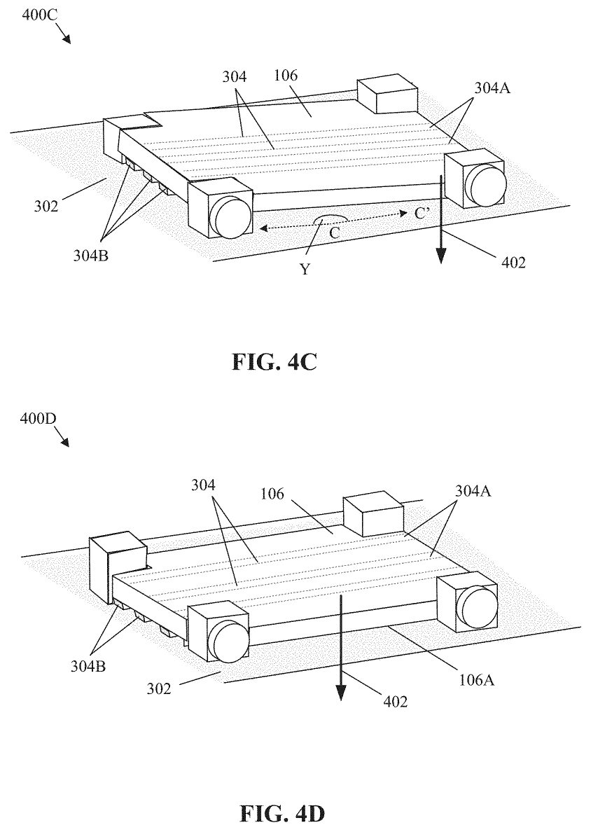

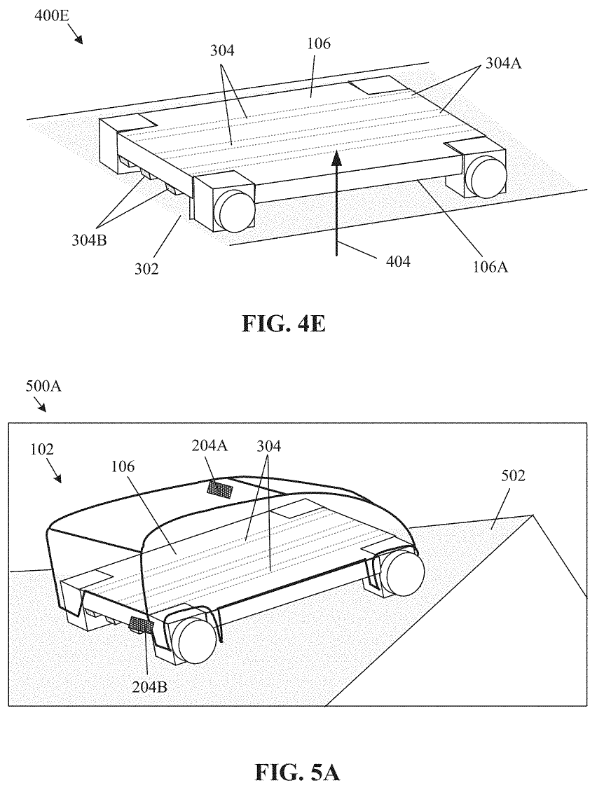

In accordance with an embodiment, the vehicle 102 may further include a retraction trigger 126 on an exterior portion of the body 104 of the vehicle 102. For example, the retraction trigger 126 may be present on a remote key of the vehicle 102 or may be near a cover, such as the first cover 116A or the second cover 1168 for a respective section of the wheel-mount location. In an exemplary embodiment, the retraction trigger 126 may be a button or a lever that may be utilized to retract the chassis 106 in a second direction. The second direction may be a direction that may be substantially opposite of the first direction (shown in FIG. 4) of the movement of the chassis 106. Once at least a portion of the motion resistance member 108 is in contact with the ground, the retraction trigger 126 may be utilized to retract the chassis 106 to an initial state. The initial state may correspond to a configuration in which the portion of the motion resistance member 108 is moved away from the ground in the second direction (opposite to the first direction).

In accordance with an embodiment, the vehicle 102 may include an electronic authentication unit that, when triggered, may actuate the retraction trigger 126. For example, in case of an emergency such as a landslide, an earthquake, or a fire hazard, the electronic authentication unit may be triggered based on a human input (e.g., an input from a driver of the vehicle 102 or a person who may handle the emergency) or a detection of the emergency to actuate the retraction trigger 126. The actuation may be performed to control the movement of the chassis 106 towards or away from the ground. Examples of the electronic authentication unit may include, but are not limited to, a sensor for fire and smoke detection, a sensor for seismic wave detection, a voice-based remote device, a fingerprint sensor, a password based device, and an IOT device that may be connected to a disaster management system for a remote activation. Details of the retraction of the chassis 106 are further provided, for example, in FIG. 4E.

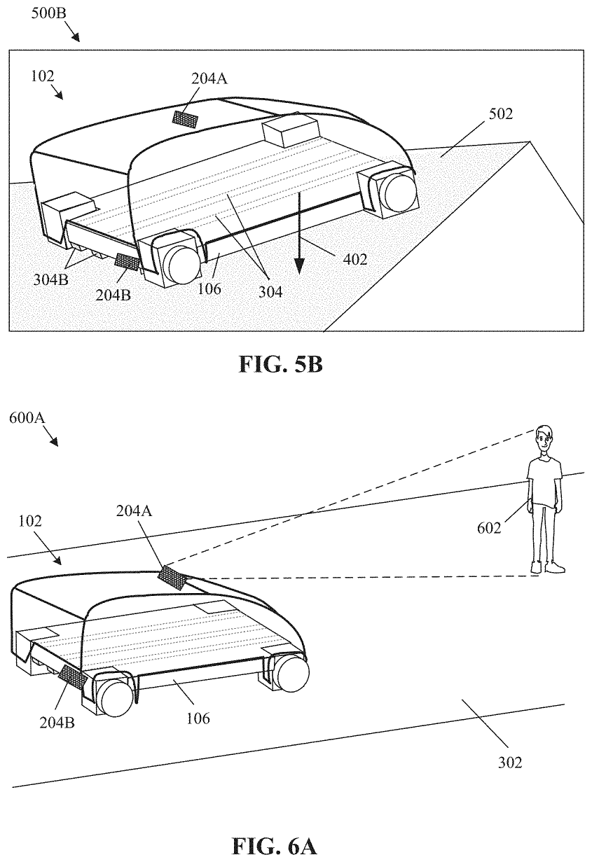

In operation, the vehicle 102 may receive a first input that may correspond to a request to allow the movement of the chassis 106 in a first direction to park or slowdown the vehicle 102. For example, the first input may be received from a user (such as a driver) or a computerized autonomous agent of the vehicle 102. In the initial state, the contact between the chassis 106 and the ground below the chassis 106 may be absent. After the first input is received, the suspension unit 120 may be actuated. Based on the actuation of the suspension unit 120, the suspension unit 120 may move the chassis 106 in a first direction until the motion resistance member 108 coupled at the base surface 106A of the chassis 106 or a portion of the motion resistance member 108 contacts the ground. By having the contact, the vehicle 102 may gain additional contact surface and friction to inhibit further motion in a specific direction. In some instances, the vehicle 102 can be safely parked on the ground as the contact patch or area between the vehicle 102 and the ground may be increase. Details of the parking of the vehicle 102 are further provided, for example, in FIGS. 5A and 5B.

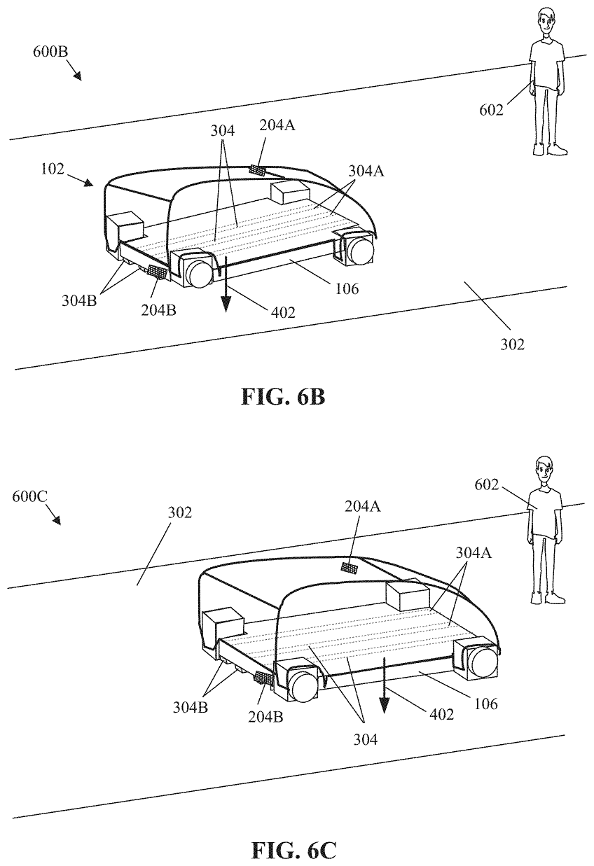

In certain scenarios, the vehicle 102 may detect an emergency-situation or an unsafe situation, such as a presence of a person portraying an unsafe behavior within a threshold distance from the vehicle 102. Based on the detection of the emergency-situation, the suspension unit 120 may be actuated. Based on the actuation of the suspension unit 120, the suspension unit 120 may move at least the portion of the chassis 106 in the first direction until the motion resistance member 108 coupled at the base surface 106A of the chassis 106 contacts the ground. The contact between the motion resistance member 108 and the ground may increase the overall contact area or patch between the vehicle 102 and the ground, thereby enhancing effect of brakes applied in the emergency or unsafe situation. Details of the emergency braking are further provided, for example, in FIGS. 6A-6C.

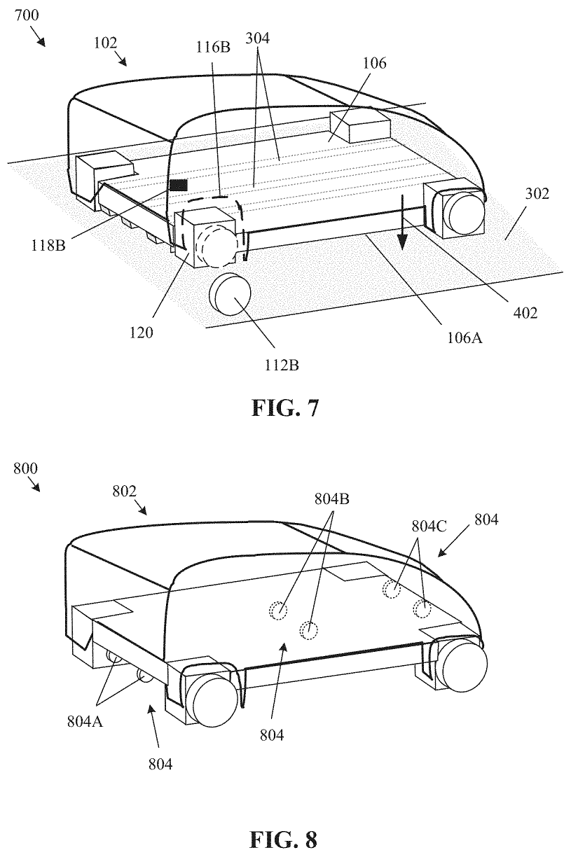

In accordance with an embodiment, one or more wheels, such as the first wheel 112A along with the first in-wheel motor 124A may be detached from the first wheel-mount location 114A once the motion resistance member 108 coupled to the base surface 106A of the chassis 106 contacts the ground. The first wheel 112A along with the first in-wheel motor 124A may be utilized to create another mobility vehicle, such as a Segway. Details of the detachment of a wheel of the set of wheels 112 are further provided, for example, in FIG. 7.

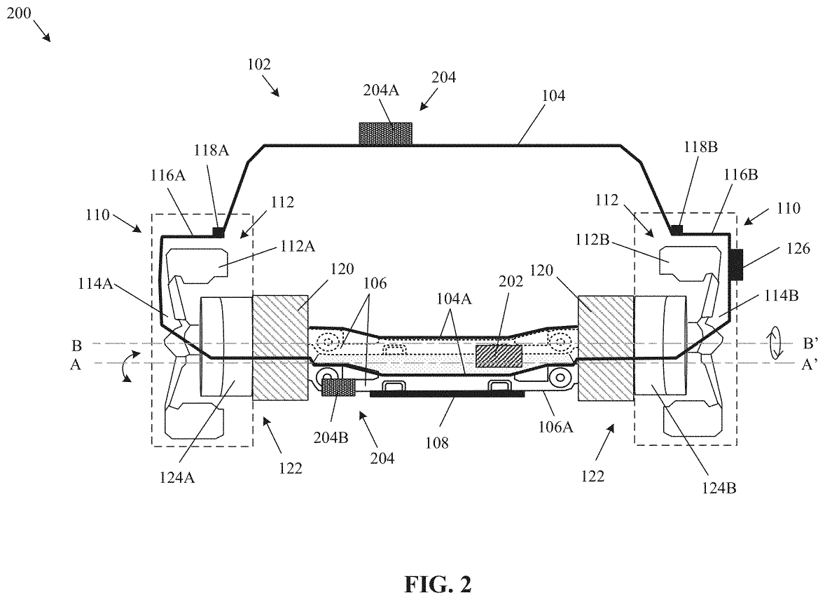

FIG. 2 is a diagram of an exemplary vehicle that includes an electronic controller coupled with a chassis, to inhibit a movement of the vehicle, in accordance with an embodiment of the disclosure. FIG. 2 is explained in conjunction with elements from FIG. 1. With reference to FIG. 1, there is shown the vehicle 102.

The vehicle 102 may include an electronic controller 202 and a set of sensors 204. In accordance with an embodiment, the electronic controller 202 may be communicatively coupled to the suspension unit 120 and may include suitable logic, circuitry, interfaces, and/or code that may be configured to change an operational state of the suspension unit 120 from an initial state to an actuated state, which may be different from the initial state. In some embodiments, the electronic controller 202 may be further configured to change the operational state of the suspension unit 120 from the actuated state to the initial state.

The electronic controller 202 may be a specialized electronic circuitry that may include an electronic control unit (ECU) processor to control different functions, such as, but not limited to, engine operations, communication operations, data acquisition operations, and other operations of the vehicle 102. The electronic controller 202 may be a microprocessor. Other examples of the electronic controller 202 may include, but are not limited to, a vehicle control system, an in-vehicle infotainment (IVI) system, an in-car entertainment (ICE) system, an automotive Head-up Display (HUD), an onboard computer, an automotive dashboard, an embedded device, a smartphone, a human-machine interface (HMI), a computer workstation, a handheld computer, a cellular/mobile phone, a portable consumer electronic (CE) device, a server, and other computing devices.

The set of sensors 204 may be positioned at different locations on the vehicle 102. For example, the set of sensors 204 may be located on an exterior portion of the body 104 of the vehicle 102 as well as on an interior portion of the body 104 of the vehicle 102. As shown, for example, the set of sensors 204 may include a first sensor 204A and a second sensor 204B. The first sensor 204A may be located at the front-end of the vehicle 102. Examples of the first sensor 204A may include, but are not limited to, an image sensor, a light detection and ranging (LiDAR) sensor, a sonar sensor, a microphone, a radio detection and ranging (RADAR) sensor, and a location sensor. In an exemplary scenario, the first sensor 204A may be the LiDAR sensor that may be configured to scan the ambient surrounding of the vehicle 102. Based on the scanned information, the electronic controller 202 may detect one or more parameters that may inform the vehicle 102 about the terrain around the vehicle 102, nearby unsafe behavior, or emergency situations.

The second sensor 204B may be located at front-end of the chassis 106 or a rear-end of the chassis 106 of the vehicle 102. Examples of the second sensor 204B may include, but are not limited to, an image sensor, a LiDAR sensor, a sonar sensor, a microphone, a RADAR sensor, and a location sensor. In an exemplary scenario, the second sensor 204B may be the image sensor, such as a camera that may be configured to scan a ground around the vehicle 102 and/or a ground below the base surface 106A of the chassis 106. Based on the scan, the electronic controller 202 may determine a presence of obstacle(s) from all surrounding locations, including the ground below the chassis 106.

A person of ordinary skill in the art will understand that the vehicle 102 may also include other suitable components and sensors, in addition to the components and the set of sensors 204 illustrated herein to describe and explain the function and operation of the present disclosure. A detailed description for such components and sensors of the vehicle 102 has been omitted from the disclosure for the sake of brevity.

FIG. 3 is a diagram that illustrates a first exemplary scenario to inhibit a movement of the vehicle of FIG. 1, in accordance with an embodiment of the disclosure. FIG. 3 is explained in conjunction with elements from FIGS. 1 and 2. With reference to FIG. 3, there is shown the vehicle 102. The vehicle 102 may be positioned on a ground 302.

The motion resistance member 108 may include one or more grip pads 304 coupled to the base surface 106A of the chassis 106. The one or more grip pads 304 may be at a certain distance from one another and may be placed along a length or a width of the chassis 106. In at least one embodiment, the motion resistance member 108 may be statically coupled to the base surface 106A of the chassis 106.

The motion resistance member 108 may be made of a rubber material or other suitable material, as described in FIG. 1. For example, the one or more grip pads 304 may be flat rubber-based grip pads that may be configured to provide a grip and contact patch to the vehicle 102, once the one or more grip pads 304 form a contact with the ground 302. The thickness of each grip pad of the one or more grip pads 304 may range from a few millimeters to a few centimeters.

The number of grip pads in FIG. 3 is presented merely as an example and should not be construed as limiting the disclosure. In some embodiments, the vehicle 102 may include only one grip pad or more than three grip pads, without departing from the scope of the disclosure.

In accordance with an embodiment, the portion of the motion resistance member 108 in contact with the ground 302 may be a surface portion of the one or more grip pads 304. The surface portion may be a base portion of the one or more grip pads 304 facing the ground 302 and lying below the base surface 106A of the chassis 106. In accordance with an embodiment, the surface portion may correspond to at least one of a first end 304A of the one or more grip pads 304 or a second end 304B of the one or more grip pads 304.

The suspension unit 120 may move the chassis 106 linearly with respect to the ground 302 to adjust the height of the chassis 106 with respect to the ground 302. The entire surface portion of the one or more grip pads 304, such as the first end 304A and the second end 304B of the one or more grip pads 304 may contact the ground 302. In some embodiments, the suspension unit 120 may move the chassis 106 non-linearly with respect to the ground 302 by adjusting the inclination of the chassis 106 with respect to the ground 302.

In accordance with an embodiment, the movement of the chassis 106 in the first direction may include a first turning movement of the first end 304A of the chassis 106 around the pivot axis AA′, followed by a second turning movement of the second end 304B of the chassis 106 around the pivot axis AA′. The pivot axis AA′ may be substantially parallel to the rotational axis BB′ of wheels (such as the set of wheels 112) of the wheel assembly 110. In an exemplary scenario, the first turning movement of the first end 304A of the chassis 106 around the pivot axis AA′ may allow the first end 304A of the chassis 106 to contact the ground 302 below the base surface 106A of the chassis 106. Thereafter, the second turning movement of the second end 304B of the chassis 106 around the pivot axis AA′ may allow the second end 304B of the chassis 106 to contact the ground 302 below the base surface 106A of the chassis 106.

FIGS. 4A, 4B, 4C, 4D, and 4E are diagrams that collectively illustrate a plurality of scenarios related to a movement of a chassis of the vehicle of FIG. 1, in accordance with an embodiment of the disclosure. FIGS. 4A, 4B, 4C, 4D, and 4E are explained in conjunction with elements from FIGS. 1, 2, and 3. In FIGS. 4A, 4B, 4C, 4D, and 4E, the body 104 of the vehicle 102 is not shown for the sake of brevity.

With reference to FIG. 4A, there is shown a first diagram 400A that includes the ground 302. During operation of the suspension unit 120 in an initial state, the contact between the one or more grip pads 304 (coupled to the base surface 106A of the chassis 106) and the ground 302 may be absent. For example, the vehicle 102 may be moving on the ground 302 or may be at rest. In such a scenario, there may be no contact between the one or more grip pads 304 and the ground 302.

With reference to FIG. 4B, there is shown a diagram 400B. The diagram 400B depicts adjustment of an inclination of the chassis 106. At any time-instant, the electronic controller 202 may be configured to change the operational state of the suspension unit 120 from the initial state to an actuated state, which may be different from the initial state. Based on the change in the operational state of the suspension unit 120 from the initial state to the actuated state, the portion of the chassis 106 may be moved in a first direction 402. As shown, for example, the second end of the chassis 106 may be moved in the first direction 402 such that the second end 304B of the one or more grip pads 304 contacts the ground 302. In some embodiments, the suspension unit 120 coupled to the rear end of the chassis 106 may be actuated. The second end 304B of the one or more grip pads 304 may be moved in the first direction 402 such that the second end 304B of the one or more grip pads 304 contacts the ground 302. In such a case, the movement of the chassis 106 may include the second turning movement of the second end of the chassis 106 around the pivot axis AA′. As shown, the inclination angle between the chassis 106 with respect to an axis CC′ (parallel to the ground 302) is X degrees.

With reference to FIG. 4C, there is shown a diagram 400C that depicts adjustment of the inclination of the chassis 106. The electronic controller 202 may be configured to change the operational state of the suspension unit 120 from the initial state to the actuated state. Based on the change in the operational state of the suspension unit 120 to the actuated state, the portion of the chassis 106 may be moved in the first direction 402. As shown, for example, the first end (or the front end) of the chassis 106 may be moved in the first direction 402, such that the first end 304A of the one or more grip pads 304 contacts the ground 302. In some embodiments, the suspension unit 120 coupled to the front end of the chassis 106 may be actuated. In such as a case, the first end 304A of the one or more grip pads 304 may be moved in the first direction 402, such that the first end 304A of the one or more grip pads 304 contacts the ground 302. The movement of the chassis 106 may include a first turning movement of the first end of the chassis 106 around the pivot axis AA′. As shown, the inclination angle between the chassis 106 with respect to the axis CC′ (parallel to the ground 302) is Y degrees.

With reference to FIG. 4D, there is shown a diagram 400D that depicts adjustment of the height of the chassis 106. In accordance with an embodiment, the electronic controller 202 may be configured to change the operational state of the suspension unit 120 from the initial state (as shown in FIG. 4A) to the actuated state. Based on the change in the operational state of the suspension unit 120 to the actuated state, the chassis 106 may be moved in the first direction 402. The movement may cause a surface portion of the one or more grip pads 304 to contact the ground 302. In an exemplary scenario, the chassis 106 may be moved in the first direction 402, such that both the first end 304A and the second end 304B of the one or more grip pads 304 contact the ground 302 at the same time.

In accordance with an embodiment, the suspension unit 120 coupled to the front end of the chassis 106 as well as to the rear end of the chassis 106 may be actuated. Based on the actuation, the first end 304A and the second end 304B of the one or more grip pads 304 may be moved in the first direction 402, such that both the first end 304A as well as the second end 304B of the one or more grip pads 304 contact the ground 302 at the nearly the same time. The movement of the chassis 106 may include a first turning movement of the first end of the chassis 106 around the pivot axis AA′ followed by a second turning movement of the second end of the chassis 106 around the pivot axis AA′. In one or more embodiments, the movement of the chassis 106 may include simultaneous parallel movement of the first end 304A and the second end 304B of the one or more grip pads 304 to contact the ground 302.

With reference to FIG. 4E, there is shown a diagram 400E that depicts a movement of the chassis 106 in a second direction 404 to break a contact between the ground 302 and a portion of the motion resistance member 108 (such as the one or more grip pads 304) in contact with the ground 302. In accordance with an embodiment, the electronic controller 202 may be configured to receive a second input via the retraction trigger 126 on the exterior portion of the body 104 of the vehicle 102. The second input may be received from a driver, a passenger, or an autonomous agent associated with the vehicle 102. Based on the second input, the electronic controller 202 may change the operational state of the suspension unit 120 from the actuated state to the initial state. Based on the change to the initial state, the suspension unit 120 may be configured to move the chassis 106 in the second direction 404 to break the contact between the ground 302 and the portion of the motion resistance member 108 (such as the one or more grip pads 304). In an exemplary scenario, the vehicle 102 may be required to be towed. In such a case, the second input may be received via the retraction trigger 126 to move the chassis 106 in the second direction 404.

FIGS. 5A and 5B are diagrams that collectively illustrate an exemplary scenario to park the vehicle of FIG. 1, in accordance with an embodiment of the disclosure. FIGS. 5A and 5B are explained in conjunction with elements from FIGS. 1, 2, 3, 4A, 4B, 4C, 4D, and 4E. With reference to FIG. 5A, there is shown a diagram 500A that includes a ground 502. The ground 502 may be, for example, an inclined road surface. At any time-instant, the vehicle 102 may have to be parked on the ground 502 by a human driver or an autonomous agent of the vehicle 102. The suspension unit 120 may be in the initial state and there may be no contact between the one or more grip pads 304 (coupled at the base surface 106A of the chassis 106) and the ground 502. Without appropriate resistance from the ground 502, it may be unsafe to park the vehicle 102 on the ground 502.

With reference to FIG. 5B, there is shown a diagram 500B that depicts a process of safe parking of the vehicle 102 on the ground 502. The electronic controller 202 may receive a first input that may correspond to a request to allow the movement of the chassis 106 in the first direction 402 to park the vehicle 102. For example, the driver (human or autonomous agent) of the vehicle 102 may provide the first input after stopping the vehicle 102 on the ground 502.

The electronic controller 202 may receive first information from one or more sensors of the set of sensors 204. The first information may indicate an absence of an obstacle on the ground 502 which may be below the base surface 106A of the chassis 106. For example, the second sensor 204B may be utilized to scan the ground 502 below the base surface 106A of the chassis 106. The second sensor 204B may transmit the first information to the electronic controller 202, based on a detection of zero obstacles on the ground 502. Thereafter, the electronic controller 202 may be configured to change the operational state of the suspension unit 120 from the initial state to the actuated state, which may be different from the initial state. The change in the operational state of the suspension unit 120 may be based on the received first input and the received first information. In the actuated state, the suspension unit 120 may move the chassis 106 in the first direction 402 until the one or more grip pads 304 contact the ground 502 below the base surface 106A of the chassis 106. As a result of the contact, contact area between the vehicle 102 and the ground 502 may increase to provide an additional force to safely park on the ground 502.

In an exemplary scenario, there may be an obstacle on the ground 502 below the base surface 106A of the chassis 106. In such a case, the electronic controller 202 may provide a notification to the driver to move the vehicle 102 away from the obstacle. For example, the electronic controller 202 may provide the notification via a display unit of a user's device or the vehicle 102. Once the vehicle 102 is at a safe distance from the obstacle, the electronic controller 202 may change the operational state of the suspension unit 120 to the actuated state. The suspension unit 120 may move the chassis 106 in the first direction 402 until the one or more grip pads 304 contacts the ground 502.

In accordance with an embodiment, the electronic controller 202 may be configured to classify the ground 502 below the base surface 106A of the chassis 106 as one of an inclined road surface, a flat road surface, an uneven surface, or a banked road surface. For example, the ground 502 may be the inclined road surface of a hill. Sensors, such as the second sensor 204B may be utilized to scan the ground 502 around the vehicle 102 and/or below the base surface 106A of the chassis 106 to classify the ground 502 as an inclined road surface. Based on the classification, the electronic controller 202 may be configured to change the operational state of the suspension unit 120 from an initial state to the actuated state.

FIGS. 6A, 6B, and 6C are diagrams that collectively illustrate an exemplary scenario for emergency braking of the vehicle of FIG. 1, in accordance with an embodiment of the disclosure. FIGS. 6A, 6B, and 6C are explained in conjunction with elements from FIGS. 1, 2, 3, 4A, 4B, 4C, 4D, 4E, 5A, and 5B. With reference to FIG. 6A, there is shown a diagram 600A. The diagram 600A depicts the vehicle 102 in motion on the ground 302.

Operations related to emergency braking are described herein. The electronic controller 202 may be configured to receive second information from one or more sensors of the vehicle 102. the second information may be associated with the vehicle 102 and an ambient surrounding of the vehicle 102. For example, the first sensor 204A may be configured to scan the ambient surrounding of the vehicle 102 to determine vehicles nearby. The ambient surrounding of the vehicle 102 may be further scanned to determine pedestrians in proximity of the vehicle 102, speeding vehicles near the vehicle 102, and obstacles, such as footpaths, barricades, and potholes on the ground 302. The one or more sensors may transmit the second information associated with the vehicle 102 and the ambient surrounding of the vehicle 102 to the electronic controller 202. As shown, for example, the second information may be related to a detected person 602 present within a threshold distance from the vehicle 102.

The electronic controller 202 may be configured to detect one or more parameters based on the received second information. Such parameters may indicate an emergency-situation associated with the vehicle 102. For example, the one or more parameters may indicate a detection of the person 602 on the road within a threshold distance from the vehicle 102. The presence of the person 602 be in proximity of the vehicle 102 may correspond to the emergency-situation as the person 602 may be attempting to cross the road or may be jaywalking at an unsafe distance from the vehicle 102. In such a case, the vehicle 102 may aid in emergency braking by moving the chassis 106 in the first direction 402. For instance, the electronic controller 202 may change the operational state of the suspension unit 120 (such as the suspension unit 120 coupled to the rear end of the vehicle 102) from an initial state to the actuated state, based on the detected one or more parameters. The suspension unit 120 in the actuated state may be configured to move the chassis 106 in the first direction 402 until at least a portion (such as the second end 304B) of the one or more grip pads 304 contacts the ground 302 below the base surface 106A of the chassis 106. The contact may increase the contact area of the vehicle 102 with the ground 302.

In accordance with an embodiment, while the second end 304B of the one or more grip pads 304 may be in contact with the ground 302, the suspension unit 120 may move the first end of the chassis 106 in the first direction 402 until a portion (such as the first end 304A) of the one or more grip pads 304 contact the ground 302 below the base surface 106A of the chassis 106, as shown in FIG. 6C. The movement of the chassis 106 may cause the entire surface portion of the one or more grip pads 304 to contact with the ground 302. Thus, the increase in the contact area may allow a skid level of the set of wheels 112 of the vehicle 102 to be controlled in case of the emergency braking. Upon contact, the portion of the one or more grip pads 304 may offer additional force that may be required to reduce the braking distance of the vehicle 102. With an appropriate maneuver of the chassis 106 in the first direction 402, the braking distance may be reduced to stop the vehicle 102 at a safe distance from the person 602.

In some embodiments, the front end of the chassis 106 may be moved down first, followed by the movement of the rear end of the chassis 106, such that the first end 304A of the one or more grip pads 304 may contact the ground 302 before the second end 304B of the one or more grip pads 304 contact the ground 302.

In accordance with an embodiment, the electronic controller 202 may be configured to determine an intensity by which accelerator or brakes are applied in the vehicle 102. For example, based on the detection of the person 602, the driver may apply the brakes on the vehicle 102. The electronic controller 202 may change the operational state of the suspension unit 120 from the initial state to the actuated state, based on the determined intensity. For example, the speed of movement of the chassis 106 in the first direction 402 may depend on the determined intensity of the brakes applied by the driver of the vehicle 102.

FIG. 7 is a diagram that illustrates an exemplary scenario to detach a wheel of the vehicle of FIG. 1, in accordance with an embodiment of the disclosure. FIG. 7 is explained in conjunction with elements from FIGS. 1, 2, 3, 4A, 4B, 4C, 4D, 4E, 5A, 5B, 6A, 6B, and 6C. With reference to FIG. 7, there is shown a diagram 700 depicting the vehicle 102. In some instances, a user may want to remove one or more wheels of the vehicle 102. For example, a second wheel 112B of the set of wheels 112 may have to be detached from the wheel assembly 110 of the vehicle 102. To facilitate the removal, the electronic controller 202 may be configured to change the operational state of the suspension unit 120 from an initial state to the actuated state. The suspension unit 120, in the actuated state, may move the chassis 106 in the first direction 402 until the surface portion of the one or more grip pads 304 contacts the ground 302.

In case the body of the vehicle 102 blocks a portion of the second wheel 112B, then the body may include a provision to unblock the second wheel 112B while the surface portion of the one or more grip pads 304 contacts the ground 302. The movement of the chassis 106 along with the body 104 of the vehicle 102 in the first direction 402 may cause a removable cover such as the second cover 116B to move over a section of the second wheel-mount location 114B to block the second wheel 112B. The second cover 116B may be removed by use of the second releasing member 118B. For example, the second releasing member 118B may be maneuvered to slide the second cover 116B in an upwards direction, in a leftward direction, or a rightward direction. With such maneuver, the user may have adequate space to detach the second wheel 112B from the vehicle 102. Similarly, other wheels of the set of wheels 112 can be detached after the removal of respective covers.

In some embodiments, the second in-wheel motor 124B may be detachable along with the second wheel 112B of the wheel assembly 110. The detached second in-wheel motor 124B along with the second wheel 112B may be utilized to create a mobility vehicle, such as a Segway or a different micro-mobility vehicle.

FIG. 8 is a diagram that illustrates a second exemplary scenario to inhibit a movement of the vehicle of FIG. 1, in accordance with an embodiment of the disclosure. FIG. 8 is explained in conjunction with elements from FIGS. 1, 2, 3, 4A, 4B, 4C, 4D, 4E, 5A, 5B, 6A, 6B, 6C, and 7. With reference to FIG. 8, there is shown a diagram 800 that includes a vehicle 802. The functions of the vehicle 802 may be same as the functions of the vehicle 102 described, for example, in FIG. 1 and FIG. 2. Therefore, the description of the vehicle 802 is omitted from the disclosure for the sake of brevity.

The vehicle 802 may include the motion resistance member 108. The motion resistance member 108 may include one or more wheels 804. Each of the one or more wheels 804 may have a size that may be less than a size of a wheel, such as the first wheel 112A of wheel assembly 110. For example, the one or more wheels 804 may include a first set of wheels 804A at the rear end of the chassis of the vehicle 802, a second set of wheels 804B at a center of the chassis of the vehicle 802, and a third set of wheels 804C at the front end of the chassis of the vehicle 802. The portion of the motion resistance member 108 that may contact the ground 302 may correspond to a surface portion of the one or more wheels 804.

The position, orientation, and number of wheels in FIG. 8 is presented merely as an example and should not be construed as limiting the disclosure. In some embodiments, the one or more wheels 804 may be more than six in number or less than six in number and may be placed at other locations and orientations, without departing from the scope of the disclosure. In some other embodiments, the one or more wheels 804 may be a part of a braking system of the vehicle 802, which may act as a motion resistant member to inhibit the movement of the vehicle 802.

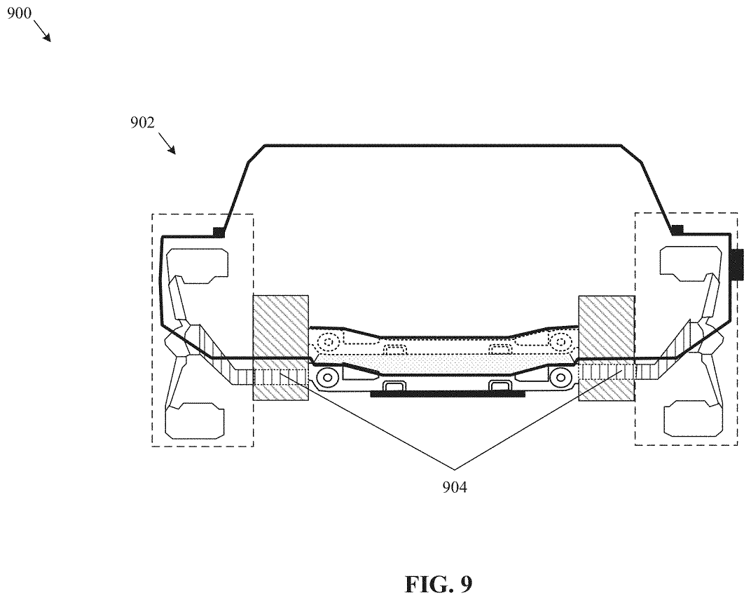

FIG. 9 is a diagram of an exemplary vehicle that includes a chassis and an axle coupled to the chassis, in accordance with an embodiment of the disclosure. FIG. 9 is explained in conjunction with elements from FIGS. 1, 2, 3, 4A, 4B, 4C, 4D, 4E, 5A, 5B, 6A, 6B, 6C, 7, and 8. With reference to FIG. 9, there is shown a diagram 900 that includes a vehicle 902. The functions of the vehicle 902 may be same as the functions of the vehicle 102 described, for example, in FIG. 1 and FIG. 2. Therefore, the description of the vehicle 902 is omitted from the disclosure for the sake of brevity. The chassis of the vehicle 902 may include an axle 904 which may be configured to hold one or more components of the wheel assembly of the vehicle 902. For example, the vehicle 902 may be a non-electric vehicle. In such a case, the axle 904 may be coupled to the chassis of the vehicle 902. The axle 904 may further be coupled to the set of wheels of the wheel assembly of the vehicle 902.

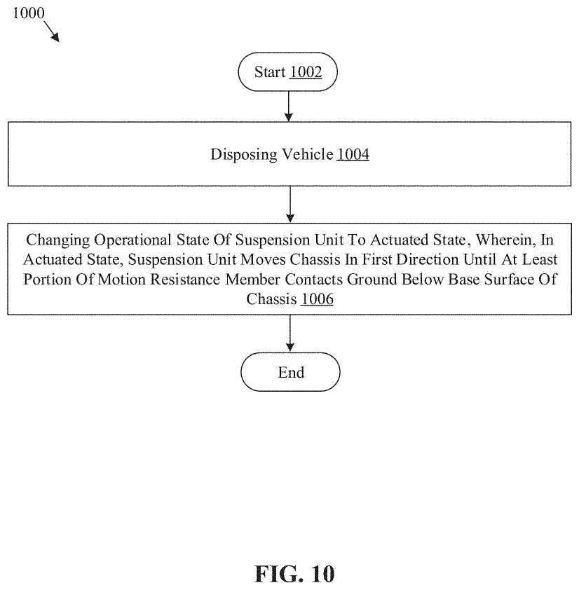

FIG. 10 is a flowchart that illustrates an exemplary method to inhibit a movement of the vehicle via the chassis of the vehicle of FIG. 1, in accordance with an embodiment of the disclosure. FIG. 10 is described in conjunction with elements from FIGS. 1, 2, 3, 4A, 4B, 4C, 4D, 4E, 5A, 5B, 6A, 6B, 6C, 7, 8, and 9. With reference to FIG. 10, there is shown a flowchart 1000. The exemplary method of the flowchart 1000 may be executed by any system, for example, by the vehicle 102 of FIG. 1 or the electronic controller 202 in FIG. 2. The exemplary method of the flowchart 1000 may start at 1002 and proceed to 1004.

At 1004, the vehicle 102 may be disposed. The vehicle 102 may include the body 104, the chassis 106 coupled to the base 104A of the body 104, and the motion resistance member 108 that may be coupled to the base surface 106A of the chassis 106. The vehicle 102 may further include the wheel assembly 110 coupled to the chassis 106 and the suspension unit 120 coupled to the wheel assembly 110 and the chassis 106.

At 1006, the operational state of the suspension unit 120 may be changed to the actuated state. In the actuated state, the suspension unit 120 may move the chassis 106 in the first direction 402 until at least the portion of the motion resistance member 108 may contact the ground 302 below the base surface 106A of the chassis 106. Control may pass to end.

Although the flowchart 1000 illustrates discrete operations, such as 1002, 1004, and 1006, the disclosure may not be so limiting. In certain embodiments, such discrete operations may be further divided into additional operations, combined into fewer operations, or eliminated, depending on the implementation without detracting from the essence of the disclosed embodiments.

Various embodiments of the disclosure may provide a non-transitory computer readable medium and/or storage medium having stored thereon, instructions executable by a machine and/or a computer (for example, the electronic controller 202). The instructions may cause the machine and/or computer (for example, the electronic controller 202) to perform operations for the adjustment of a chassis (such as the chassis 106) for motion resistance in a vehicle (such as the vehicle 102). The operations may include dispose of the vehicle 102. The vehicle 102 may include a body (such as the body 104), and the chassis 106 coupled to the body 104. The vehicle 102 may further include a motion resistance member (such as the motion resistance member 108) that may be coupled to a base surface (such as the base surface 106A) of the chassis 106. The vehicle 102 may further include a wheel assembly (such as the wheel assembly 110) coupled to the chassis 106, and a suspension unit 120 coupled to the wheel assembly 110 and the chassis 106. The operations may further include change of an operational state of the suspension unit 120 to an actuated state. In the actuated state, the suspension unit 120 may move the chassis 106 in a first direction (such as the first direction 402) until at least a portion of the motion resistance member 108 may contact a ground (such as the ground 302) below the base surface 106A of the chassis 106.

Exemplary aspects of the disclosure may include a vehicle 102. The vehicle 102 may include a body (such as the body 104), and the chassis 106 coupled to the body 104. The vehicle 102 may further include a motion resistance member (such as the motion resistance member 108) that may be coupled to a base surface (such as the base surface 106A) of the chassis 106. The vehicle 102 may further include a wheel assembly (such as the wheel assembly 110) coupled to the chassis 106, and a suspension unit 120 coupled to the wheel assembly 110 and the chassis 106. In the actuated state, the suspension unit 120 may be configured to move the chassis 106 in a first direction (such as the first direction 402) until at least a portion of the motion resistance member 108 may contact a ground (such as the ground 302) below the base surface 106A of the chassis 106.

In accordance with an embodiment, the motion resistance member 108 may include the one or more grip pads 304 coupled to the base surface 106A of the chassis 106. The one or more grip pads 304 may be at equal distance from one another along a length of the chassis 106, and the portion of the motion resistance member 108 that contacts the ground 302 may include a surface portion of the one or more grip pads 304.

In accordance with an embodiment, the surface portion may correspond to at least one of the first end 304A of the one or more grip pads 304 or the second end 304B of the one or more grip pads 304.

In accordance with an embodiment, the motion resistance member 108 may include the one or more wheels 804. Each of the one or more wheels 804 may have a size that may be less than a size of a wheel in the wheel assembly 110. The portion of the motion resistance member 108 that contacts the ground 302 may correspond to a surface portion of the one or more wheels 804.

In accordance with an embodiment, the movement of the chassis 106 in the first direction 402 may correspond to adjustment of at least one of a height of the chassis 106 or an inclination of the chassis 106 with respect to the ground 302 below the base surface 106A of the chassis 106.

In accordance with an embodiment, the movement of the chassis 106 in the first direction 402 may include a first turning movement of the first end 304A of the chassis 106 around the pivot axis AA′, followed by a second turning movement of the second end 304B of the chassis 106 around the pivot axis AA′. The pivot axis AA′ may be substantially parallel to the rotational axis BB′ of wheels of the wheel assembly 110.

In accordance with an embodiment, wheel assembly 110 may include the set of wheels 112 disposed in the set of wheel-mount locations on the body 104 of the vehicle 102. Each wheel of the set of wheels 112 may be detachably coupled to the respective part of the chassis 106.

In accordance with an embodiment, the body 104 may include the cover, such as the first cover 116A over the section of each wheel-mount location, such as the first wheel-mount location 114A of the set of wheel-mount locations. Each wheel of the set of wheels 112 may be detachable after a removal of the cover and after the portion of the motion resistance member 108 may contact the ground 302.

In accordance with an embodiment, the vehicle 102 may further include the drive system 122 that may include the in-wheel motor, such as the first in-wheel motor 124A around each wheel of the set of wheels 112. Each wheel of the set of wheels 112 may be powered by the in-wheel motor.

In accordance with an embodiment, the chassis 106 may further include the axle 904 which may be configured to hold one or more components of the wheel assembly 110.

In accordance with an embodiment, the suspension unit may correspond to the active suspension mechanism.

In accordance with an embodiment, the vehicle 102 may further include the electronic controller 202 communicatively coupled to the suspension unit 120.

In accordance with an embodiment, the electronic controller 202 may be further configured to change the operational state of the suspension unit 120 from the initial state to the actuated state, which may be different from the initial state.

In accordance with an embodiment, the vehicle 102 may further include the set of sensors 204. The electronic controller 202 may be communicatively coupled to the set of sensors 204. The electronic controller 202 may be configured to receive the first input corresponding to the request to allow the movement of the chassis 106 in the first direction 402 to park the vehicle 102. The electronic controller 202 may receive the first information from one or more sensors of the set of sensors 204. The first information may indicate the absence of the obstacle on the ground 502 which may be below the base surface 106A of the chassis 106. The electronic controller 202 may be configured to change the operational state of the suspension unit 120 from the initial state to the actuated state, which may be different from the initial state. The change may be based on the received first input and the received first information.

In accordance with an embodiment, the electronic controller 202 may be configured to classify the ground 302 below the base surface 106A of the chassis 106 as one of: the inclined road surface, the flat road surface, the uneven surface, or the banked road surface. The electronic controller 202 may further change the operational state of the suspension unit 120 from the initial state to the actuated state, based on the classification.

In accordance with an embodiment, the electronic controller 202 may be configured to determine the intensity by which the accelerator or brakes may be applied in the vehicle 102. The electronic controller 202 may further change the operational state of the suspension unit 120 from the initial state to the actuated state, based on the determined intensity.

In accordance with an embodiment, the electronic controller 202 may be configured to receive the second information from one or more sensors of the vehicle 102. The second information may be associated with the vehicle 102 and the ambient surrounding of the vehicle 102. The electronic controller 202 may detect the one or more parameters based on the received second information. The one or more parameters may indicate the emergency-situation associated with the vehicle 102. The electronic controller 202 may change the operational state of the suspension unit 120 from the initial state to the actuated state, based on the detected one or more parameters.

In accordance with an embodiment, the vehicle 102 may further include the retraction trigger 126 on the exterior portion of the body 104 of the vehicle 102. The electronic controller 202 may be further configured to receive the second input via the retraction trigger 126 on the exterior portion of the body 104 of the vehicle 102. The electronic controller 202 may change the operational state of the suspension unit 120 from the actuated state to the initial state, based on the received second input. Based on the change to the initial state, the suspension unit 120 may be configured to move the chassis 106 in the second direction 404 to break the contact between the ground 302 and the portion of the motion resistance member 108.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions. It may be understood that, depending on the embodiment, some of the steps described above may be eliminated, while other additional steps may be added, and the sequence of steps may be changed.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form. While the present disclosure has been described with reference to certain embodiments, it will be understood by those skilled in the art that various changes may be made, and equivalents may be substituted without departing from the scope of the present disclosure. In addition, many modifications may be made to adapt a situation or material to the teachings of the present disclosure without departing from its scope. Therefore, it is intended that the present disclosure is not limited to the embodiment disclosed, but that the present disclosure will include all embodiments that fall within the scope of the appended claims.

What is claimed is:

1. A vehicle, comprising:
a body;
a chassis coupled to a base of the body;
a motion resistance member that is coupled to a base surface of the chassis;
a wheel assembly coupled to the chassis; and
a suspension unit coupled to the wheel assembly and the chassis,
wherein, in an actuated state, the suspension unit is configured to move the chassis in a first direction until at least a portion of the motion resistance member contacts a ground below the base surface of the chassis.

2. The vehicle according to claim 1, wherein the motion resistance member comprises one or more grip pads coupled to the base surface of the chassis, and
wherein the one or more grip pads are at equal distance from one another along a length of the chassis, and the portion of the motion resistance member that contacts the ground consists of a surface portion of the one or more grip pads.

3. The vehicle according to claim 2, wherein the surface portion corresponds to at least one of: a first end of the plurality of grip pads or a second end of the plurality of grip pads.

4. The vehicle according to claim 1, wherein the motion resistance member comprises one or more wheels, and
wherein each of the one or more wheels have a size that is less than a size of a wheel in wheel assembly, and
the portion of the motion resistance member that contacts the ground corresponds to a surface portion of the one or more wheels.

5. The vehicle according to claim 1, wherein the movement of the chassis in the first direction corresponds to adjustment of at least one of a height of the chassis or an inclination of the chassis with respect to the ground below the base surface.

6. The vehicle according to claim 1, wherein the movement of the chassis in the first direction comprises a first turning movement of a first end of the chassis around a pivot axis, followed by a second turning movement of a second end of the chassis around the pivot axis, and
wherein the pivot axis is substantially parallel to a rotational axis of wheels of the wheel assembly.

7. The vehicle according to claim 1, wherein the wheel assembly comprises a set of wheels disposed in a set of wheel-mount locations on the body of the vehicle,
wherein each wheel of the set of wheels is detachably coupled to a respective part of the chassis.

8. The vehicle according to claim 7, wherein the body comprises a cover over a section of each wheel-mount location of the set of wheel-mount locations, and
wherein each wheel of the set of wheels is detachable after a removal of the cover and after the portion of the motion resistance member contacts the ground.

9. The vehicle according to claim 7, further comprising a drive system that includes an in-wheel motor around each wheel of the set of wheels, wherein each wheel of the set of wheels is powered by the in-wheel motor.

10. The vehicle according to claim 1, wherein the chassis further comprises an axle which is configured to hold one or more components of the wheel assembly.

11. The vehicle according to claim 1, wherein the suspension unit corresponds to an active suspension mechanism.

12. The vehicle according to claim 1, wherein the vehicle further comprises an electronic controller communicatively coupled to the suspension unit.

13. The vehicle according to claim 12, wherein the electronic controller is configured to change an operational state of the suspension unit from an initial state to the actuated state, which is different from the initial state.

14. The vehicle according to claim 12, further comprising:
a set of sensors;
an electronic controller communicatively coupled to the set of sensors, wherein the electronic controller is configured to:
receive a first input corresponding to a request to allow the movement of the chassis in the first direction to park the vehicle; and
receive first information from one or more sensors of the set of sensors, wherein the first information indicates an absence of an obstacle on the ground which is below the base surface of the chassis, wherein
the electronic controller is configured to change an operational state of the suspension unit from an initial state to the actuated state, which is different from the initial state, and
the change is based on the received first input and the received first information.

15. The vehicle according to claim 12, wherein the electronic controller is configured to:
classify the ground below the base surface of the chassis as one of an inclined road surface, a flat road surface, an uneven surface, or a banked road surface; and
change an operational state of the suspension unit from an initial state to the actuated state, based on the classification.

16. The vehicle according to claim 12, wherein the electronic controller is further configured to:
determine an intensity by which an accelerator or brakes are applied in the vehicle;
change an operational state of the suspension unit from an initial state to the actuated state, based on the determined intensity.

17. The vehicle according to claim 12, wherein the electronic controller is configured to:
receive second information from one or more sensors of the set of sensors, wherein the second information is associated with the vehicle and an ambient surrounding of the vehicle;
detect one or more parameters based on the received second information, wherein the one or more parameters indicate an emergency-situation associated with the vehicle; and
change an operational state of the suspension unit from an initial state to the actuated state, based on the detected one or more parameters.

18. The vehicle according to claim 12, further comprising a retraction trigger on an exterior portion of the body of the vehicle, wherein the electronic controller is further configured to:
receive a second input via the retraction trigger on the exterior portion of the body of the vehicle; and
change an operational state of the suspension unit from the actuated state to an initial state, based on the received second input,
wherein, based on the change to the initial state, the suspension unit is configured to move the chassis in a second direction to break the contact between the ground and the portion of the motion resistance member.

19. A method, comprising:
disposing a vehicle, wherein the vehicle comprises:
a body;
a chassis coupled to a base of the body;
a motion resistance member that is coupled to a base surface of the chassis;
a wheel assembly coupled to the chassis; and
a suspension unit coupled to the wheel assembly and the chassis,
changing an operational state of the suspension unit to an actuated state, wherein, in the actuated state, the suspension unit moves the chassis in a first direction until at least a portion of the motion resistance member contacts a ground below the base surface of the chassis.

20. The method according to claim 19, wherein the motion resistance member comprises one or more grip pads coupled to the base surface of the chassis, and
wherein the one or more grip pads are at equal distance from one another along a length of the chassis, and the portion of the motion resistance member that contacts the ground consists of a surface portion of the one or more grip pads.
